(19) United States
(12) Patent Application Publication
(10) Pub. No.: US 2002/0188730 A1
(43) Pub. Date: Dec. 12, 2002

(54) Method and system for a modular transmission control protocol (TCP) frequent-handoff design in a streams based transmission control protocol internet protocol (TCP/IP) implementation

(76) Inventors: Wenting Tang, Mountain View, CA (US); Ludmila Cherkasova, Sunnyvale, CA (US); Lance Russell, Hollister, CA (US)

Correspondence Address: HEWLETT-PACKARD COMPANY, Intellectual Property Administration, P.O. Box 272400, Fort Collins, CO, 80527-2400, US

(21) Appl. No.: 09/880,217

(22) Filed: Jun. 12, 2001

(51) Int. Cl. G06F 15/16

(52) U.S. Cl. 709/227; 709/230

(57) ABSTRACT

A method and system for handing-off TCP states in a communication network. Specifically, the present invention allows for handing-off TCP states between nodes in an associated network that is optimized for frequent handoff of TCP states. The handoff occurs between dynamically loadable modules that wrap around the TCP/IP stack located at a front-end server and a selected back-end server. A handoff protocol implemented by the loadable modules works within the kernel level of the existing TCP/IP code. As such, no changes to the existing TCP/IP code is necessary. The loadable modules at the front-end are able to select a back-end server depending on the content of the HTTP request, coordinate handing off TCP states, and forward packets to the back-end server. Loadable modules at the selected back-end modify response packets to reflect the proper TCP state of the front-end server.

### BACKGROUND OF THE INVENTION

1. Field of the Invention

The present invention relates to the field of STREAMS-based Transmission Control Protocol/Internet (TCP/IP) protocols. Specifically, the present invention relates to the field of modular implementation of a TCP frequent-handoff protocol in order to facilitate the transfer or migration of TCP states from one node to another node in a communication network. The present invention further relates to the field of content-aware request distribution in a web server cluster.

2. Related Art

Web server clusters are the most popular configurations used to meet the growing traffic demands imposed by the Internet. However, for web server clusters to be able to achieve scalable performance, when the cluster size increases, it is imperative that the cluster employs some mechanism and/or policy for balanced request distribution. For instance, it is important to protect web server clusters from network overload and to provide service differentiation when different client requests compete for limited server resources. Mechanisms for intelligent request distribution and request differentiation help to achieve scalable and predictable cluster performance and functionality, which are essential for today's Internet web sites.

Traditional request distribution methods try to distribute the requests among the nodes in a web cluster based on certain parameters, such as, IP addresses, port numbers, and load information. Some of these request distribution methods have the ability to check the packet header up to Layer 4 in the International Organization for Standardization Open Systems Interconnection (ISO/OSI) network reference model (e.g., TCP/IP) in order to make the distribution decision. As such, these methods are commonly referred to as Layer 4 request distributions.

FIG. 1 shows a communication network 100 of the prior art that illustrates a load balancing solution. In FIG. 1, a web server cluster 150 is shown. The cluster 150 can be a web site with a virtual IP address located at the load balancer 152. Various back-end servers, such as back-end server-1 155, back-end server-2 157, on up to back-end server-n 159 contain the content provided by the web site.

Typically, the load-balancer 152 sits as a front-end node on a local network and acts as a gateway for incoming connections. The load balancer 152 is also called a request distributor 152. Requests for content can come through the Internet 120 from various clients, such as client-1 110, client-2 112, on up to client-n 114. Incoming client requests are distributed, more or less, evenly to the pool of back-end servers, without regard to the requested content. Further, the load balancer 152 forwards client requests to selected back-end nodes prior to establishing a connection with the client.

The three-way handshaking and the connection set up with the original client is the responsibility of the back-end web server. After the connection is established, the client sends to the back-end web server the HTTP request with the specific URL for retrieval.

In this configuration, the web server cluster 150 appears as a single host to the clients. To the back-end web servers in a web cluster 150, the front-end load-balancer 152 appears as a gateway. In essence, it intercepts the incoming connection establishment packets and determines which back-end server should process a particular request. Proprietary algorithms implemented in the front-end load balancer 152 are used to distribute the requests. These algorithms can take into account the number of back-end servers available, the resources (CPU speed and memory) of each back-end server, how many active TCP sessions are being serviced, etc. The balancing methods across different load-balancing servers vary, but in general, requests are forwarded to the least loaded back-end server in the cluster 150.

In addition, only the virtual address located at the load balancer 152 is advertised to the Internet community, so the load balancer also acts as a safety net. The IP addresses of the individual back-end servers are never sent back to the web browser located at the client making a request, such as client 110. The load-balancer rewrites the virtual cluster IP address to a particular web server IP address using Network Address Translation (NAT).

However, because of this IP address rewriting, both inbound requests and outbound responses must pass through the load-balancer 152. This creates a bottleneck and limits the scalability of the cluster 150.

A better method for web request distribution takes into account the content (such as URL name, URL type, or cookies) of an HTTP web request when making a routing decision to a web server. The main technical difficulty of this approach is that it requires the establishment of a connection between the client and the request distributor. After the connection is established, the client sends the HTTP web request to a request distributor, which decides which web server to forward the HTTP web request for processing.

In this approach, the three-way handshaking protocol and the connection set up between the client and the request distributor happens first as shown in Prior Art FIG. 2. A request distributor 240 sets up the connection with the client (e.g., client-1 210). After that, a back-end web server (e.g., web server-1 232) is chosen by the request distributor 240 based on the content of the HTTP web request from the client-1 210. The request distributor 240 can be located at a front-end node that accesses a web cluster 230 containing a plurality of web servers, such as web server-1 232, web server-2, 234, on up to web server-n 236.

In the Internet environment, the hypertext transfer protocol (HTTP) protocol is based on the connection-oriented TCP protocol. In order to serve a client request, a TCP connection must first be established between a client and a server node. If the front-end node cannot or should not serve the request, some mechanism is needed to forward the request for processing to the right node in the web cluster.

The TCP handoff mechanism allows distribution of HTTP web requests on the basis of requested content and the sending of responses directly to the client-1 210. In this mechanism, the request distributor 240 transfers TCP states from the request distributor 240 to the selected back-end web server 232.

Previously, various mechanisms for transferring TCP states were implemented, including using a separate proprietary protocol at the application layer of an operating system. For example, in the Brendel et al. patent (U.S. Pat. No. 5,774,660), incoming packets to the front-end node have their protocol changed from TCP/IP protocol to a non-TCP/IP standard that is only understood by the proprietary protocol located at the application layer. Later, the packets are changed back to the TCP/IP protocol for transmission to the back-end web server. Thus, the Brendel et al. patent reduces processing efficiency by switching back and forth between the user-level and kernel level layers of the operating system.

Thus, a need exists for a more efficient design for implementing a mechanism for transferring TCP states in a web server cluster.

### SUMMARY OF THE INVENTION

Accordingly, a method and system for a method and system for a modular transmission control protocol (TCP) frequent-handoff design in a STREAMS-based transmission control protocol Internet protocol (TCP/IP) implementation is described. Embodiments of the present invention provide for better management flexibility as TCP frequent-handoff (STREAMS) modules can be dynamically loaded and unloaded as dynamically loadable kernel modules (DLKM) without service interruption. In addition, embodiments of the present invention provide better portability between different operating systems since the TCP frequent-handoff modules can be ported to other STREAMS-based TCP/IP operating systems implementing the TCP/IP protocol. Also, embodiments of the present invention provide for upper layer transparency in that no application modifications are necessary to take advantage of new solutions: modifications are made at the kernel level in the DLKM TCP frequent-handoff modules without modifying the operating system. Further, embodiments of the present invention meet the above needs as well as providing for better efficiency in processing web requests since the handoff modules only peek into message traffic with minimum functional replication of the original TCP/IP modules.

These and other objects and advantages of the present invention will no doubt become obvious to those of ordinary skill in the art after having read the following detailed description of the preferred embodiments which are illustrated in the various drawing figures.

Specifically, the present invention discloses a method and system for routing web requests between cooperative nodes either locally or in a wide area network. The routing is implemented by handing off TCP states between the cooperative nodes. The cooperative nodes can be a web cluster of associated web server computers. The cluster of associated servers contain content that is partitioned or partially replicated between each of the associated servers. The web cluster could be a web site that is coupled to a communication network, such as the Internet.

The handoff mechanism is designed around the network architecture of the web cluster. The present invention optimizes the TCP handoff design for the case when TCP handoffs are frequent, in that web requests received at a front-end node will usually be processed at a remote location, a back-end web server, in the web cluster, in accordance with one embodiment of the present invention. Additionally, a dispatcher node has access to a mapping table of the network architecture that allows selection of the proper server in the cluster based on content of the web request. The proposed design is optimized to minimize the necessary procedures for remote processing of web requests while possibly decreasing the efficiency of local processing of web requests.

Every node or server computer in the web cluster is homogeneously structured in order to implement the TCP frequent-handoff mechanism. Each node can operate as a front-end server node that receives a web request, or as a remotely located back-end server node that receives a forwarded web request for processing. STREAMS-based TCP frequent-handoff modules determine if the web request will be handled locally or remotely.

When handled remotely, the TCP frequent-handoff modules initiate the TCP frequent-handoff process, migrate the TCP states, forward data packets, and close all connections when the communication session is closed. The TCP frequent-handoff mechanism is designed to improve performance of remote processing of requests at a minimal cost of additional steps for local processing of requests.

For remote processing of web requests, TCP state migration begins with establishing a TCP/IP communication session between a client computer and a front-end node. The communication session is established at a bottom TCP (BTCP) module located below a TCP module in an operating system at the front-end node. In this way, the TCP module and upper layer applications are completely transparent when establishing communication session.

The front end node is part of a plurality of web server nodes that form a web server cluster. The web server cluster contains information that may be partitioned or partially replicated at each of the web server nodes. The communication session is established for the transfer of data contained within the information.

After the communication session is established between the front-end node and the client computer, the BTCP module examines the content of the HTTP request in order to determine which node in the web server cluster can best service the HTTP request. The TCP frequent-handoff protocol coordinates handing off said TCP/IP communication session from the BTCP module to the selected back-end web server.

The handoff occurs over a persistent control channel that is coupled to each of the nodes in the web server cluster. As such, TCP frequent-handoff modules at one node can communicate with other TCP frequent-handoff modules at any other node in the web server cluster to coordinate TCP state migration.

TCP state migration between the front-end node and the selected back-end web server allows the BTCP modules at both the front-end and selected back-end web server to understand the correct TCP states and IP addresses for messages sent out of both nodes. Thus, message or data packets associated with the communication session can be updated to reflect proper TCP states and be properly directed to the correct IP address depending on where the packets originated from and where they are received.

State migration is conducted by the TCP frequent-handoff modules at both the front-end node and the selected back-end web server with a proprietary TCP frequent-handoff protocol that is optimized for frequent TCP handoffs, in accordance with one embodiment of the present invention.

The BTCP module of the front-end node sends a handoff request message over the control channel to the BTCP module of the selected back-end web server. The handoff message includes initial TCP state information associated with the BTCP module located at the front-end node.

At the back-end web server, the BTCP module reconstructs the connection setup messages to an upper layered TCP module in order to migrate the TCP state of the front-end node and to obtain the TCP state of the TCP module at the back-end web server. The BTCP module at the back-end web server sends a handoff acknowledgment message back to the front-end node over the control channel. The acknowledgment message contains initial TCP state information for the TCP module at the back-end web server. In this way, both the front-end node and the back-end web server understand the proper TCP states and destination addresses to conduct the communication session. The client as well as the upper application layers of the front-end node are transparent to the process of state migration and handoff.

After successful handoff of the TCP states between the front-end node and the selected back-end web server, the BTCP module at the front-end enters into a forwarding mode. As such, incoming packets coming from the client to the front-end node are updated to reflect the proper TCP state of the selected back-end web server, properly re-addressed, and forwarded to the selected back-end web server. Updating of the TCP states is necessary since the incoming packets, originally configured to reflect the TCP state of the BTCP module at the front-end node, is being forwarded to the selected back-end web server whose TCP state is most likely different from that of the BTCP module at the front-end node.

Similarly, response packets from the selected back-end web server are also updated by BTCP module of the back-end web server to reflect the proper TCP state of the BTCP module at the front-end node before being sent to the client. Updating is necessary since the client expects packets to reflect TCP states related to the connection made between the client and the front-end node. In this way, response packets from the back-end web server can be directly sent to the client through a communication path that does not include the front-end node.

Termination of the communication session should free TCP states at both the front-end node and the back-end web server. Data structures at the selected back-end web server are closed by the TCP/IP STREAMS mechanism. The BTCP module at the selected back-end web server monitors the handoff connection and the TCP/IP control traffic and notifies the BTCP module at the front-end node through the control channel when the communication session is closed. The BTCP module at the front-end server then releases the resources related to the forwarding mechanism.

### BRIEF DESCRIPTION OF THE DRAWINGS

PRIOR ART FIG. 1 illustrates a block diagram of an exemplary communication network implementing traditional load balancing solutions.

PRIOR ART FIG. 2 illustrates a block diagram of a communication network environment that is able to examine the content of a web request for distribution.

FIG. 3 illustrates a block diagram of an exemplary communication network environment including a front-end web server coupled to back-end web servers for implementing a modular transmission control protocol (TCP) frequent-handoff design in a STREAMS-based transmission control protocol Internet protocol (TCP/IP) implementation, in accordance with one embodiment of the present invention.

FIG. 4 illustrates a block diagram of an exemplary communication network environment showing the connections between a front-end node of a web cluster and a selected back-end web server of the web cluster for a communication session established through the TCP frequent-handoff design, in accordance with one embodiment of the present invention.

FIG. 5A illustrates a block diagram of an exemplary STREAM-based modular framework for TCP/IP implementation, in accordance with one embodiment of the present invention.

FIG. 5B illustrates a block diagram of the standard STREAMS-based modules used for TCP/IP implementation, in accordance with one embodiment of the present invention.

FIG. 5C illustrates a block diagram of new STREAMS-based plug-in modules used for TCP handoff in STREAMS-based TCP/IP implementation, in accordance with one embodiment of the present invention.

FIG. 6 illustrates a block diagram of an exemplary web server cluster environment including a plurality of homogeneous server computers, capable of implementing the TCP frequent-handoff design, that are coupled through a local area network, in accordance with one embodiment of the present invention.

FIG. 7 is a flow diagram illustrating steps in a method for migrating TCP states from the front-end server to a selected back-end web server when web requests are processed at a remote back-end web server, in accordance with one embodiment of the present invention.

FIG. 8 illustrates a block diagram of an exemplary TCP frequent-handoff architecture that shows the request processing flow during a TCP frequent-handoff procedure, in accordance with one embodiment of the present invention.

FIG. 9 is a flow diagram illustrating steps in a method for processing a typical client request in a TCP frequent-handoff design, in accordance with one embodiment of the present invention.

FIG. 10 is a flow diagram illustrating steps in a method for establishing a connection between a client and a front-end server, in accordance with one embodiment of the present invention.

FIG. 11 is a flow diagram illustrating steps in a method for initiating and handing off the TCP state of the front-end node, in accordance with one embodiment of the present invention.

FIG. 12 is a flow diagram illustrating steps in a method for migrating the TCP state of the front-end node to the selected back-end web server, in accordance with one embodiment of the present invention.

FIG. 13 is a flow diagram illustrating steps in a method for forwarding incoming traffic from the front-end node to the selected back-end web server, in accordance with one embodiment of the present invention.

FIG. 14 is a flow diagram illustrating steps in a method for sending response packets from the selected back-end web server directly to the client, in accordance with one embodiment of the present invention.

### DETAILED DESCRIPTION OF THE INVENTION

Reference will now be made in detail to the preferred embodiments of the present invention, a method and system for implementing TCP frequent-handoff in a STREAMS-based TCP/IP implementation, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Accordingly, a method and system for a modular Transmission Control Protocol (TCP) frequent-handoff design in a STREAMS-based Transmission Control Protocol Internet Protocol (TCP/IP) implementation is described. Embodiments of the present invention provide for better management flexibility as TCP frequent-handoff (STREAMS) modules can be dynamically loaded and unloaded as dynamically loadable kernel modules (DLKM) without service interruption. In addition, embodiments of the present invention provide for better portability between different operating systems since the TCP frequent-handoff modules can be ported to other STREAMS-based TCP/IP operating systems implementing the TCP/IP protocol. Also, embodiments of the present invention provide for upper layer transparency in that no application modifications are necessary to take advantage of new solutions: modification are made at the kernel level in the DLKM TCP frequent-handoff modules without modifying the operating system. Further, embodiments of the present invention provide for better efficiency in processing web requests since the handoff modules only peek into message traffic with minimum functional replication of the original TCP/IP modules.

Content Aware Request Distribution

Content-aware request distribution takes into account the content (URL name, URL type, or cookies, etc.) when making a decision as to which back-end server can best process the HTTP request. Content-aware request distribution mechanisms enable smart, specially tailored routing inside the web cluster.

Some benefits achieved in content-aware request distribution include allowing only partial replication of the content for a web site. Most, if not all, of the content provided by a web site server cluster can be completely partitioned. Also, content can also be partially replicated between each of the nodes of the web server cluster. Additionally, the web site can further partition content based on specialization of information. For example, dedicated back-end servers can be set up to deliver different types of documents. Another benefit provided by content-aware distribution includes support for differentiated Web Quality of Service (Web QoS).

Content-aware request distribution based on cache affinity lead to significant performance improvements compared to strategies that only take into account load information.

Three main components comprise a web server cluster configuration in implementing a content-aware request distribution strategy: a dispatcher, a distributor, and a web server. The dispatcher implements the request distribution strategy and decides which web server will be processing a given request. The distributor interfaces with the client and implements the TCP handoff in order to distribute the client requests to a specific web server. The web server processes the client requests, or HTTP requests.

In the Internet environment, the hypertext transfer protocol (HTTP) protocol is based on the connection-oriented TCP protocol. In order to serve a client request, a TCP connection is first established between a client and a front-end node. A dispatcher component is accessed by the front-end node to determine which web server can process the web request. The dispatcher component may be located at the front-end node. A web server at the front-end node may be selected in which case, local processing of the web request occurs at the front-end node.

However, if the selected web server is not located at the front-end node, some mechanism is needed to forward the web request for processing to the right node in the web cluster. In this case, a distributor component supports the handing off of TCP states between the front-end node to the selected web server located at another node, a back-end web server, in the web cluster. Hence, the selected web server can also be referred to as the back-end web server.

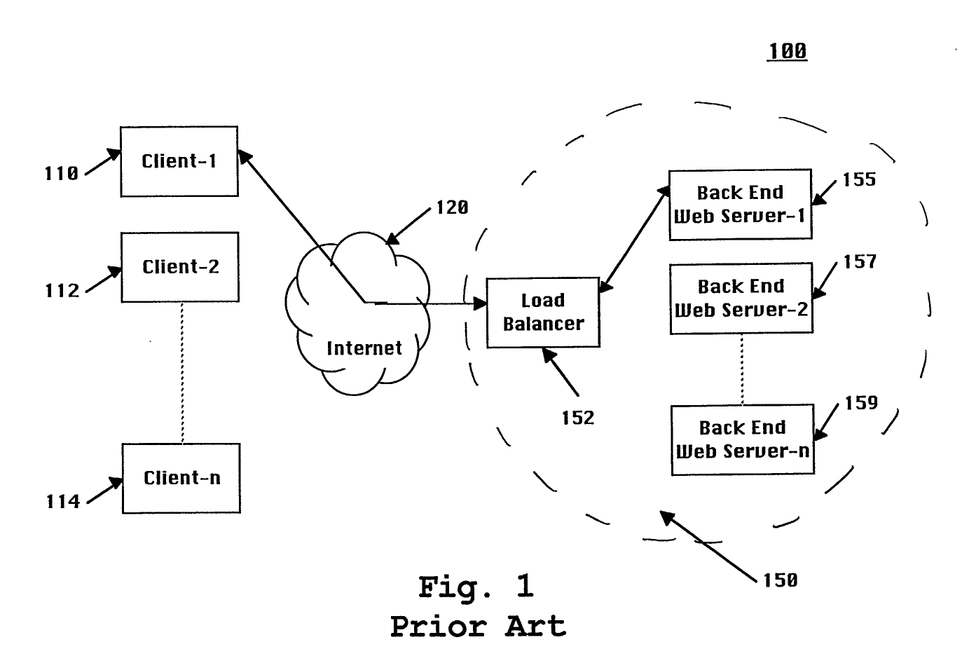

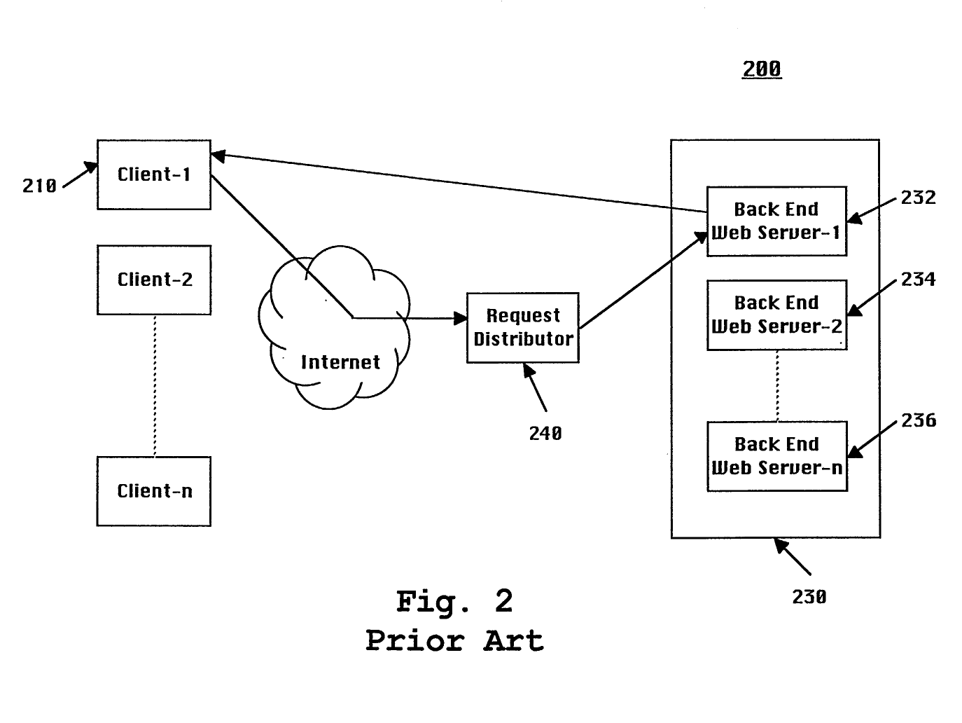

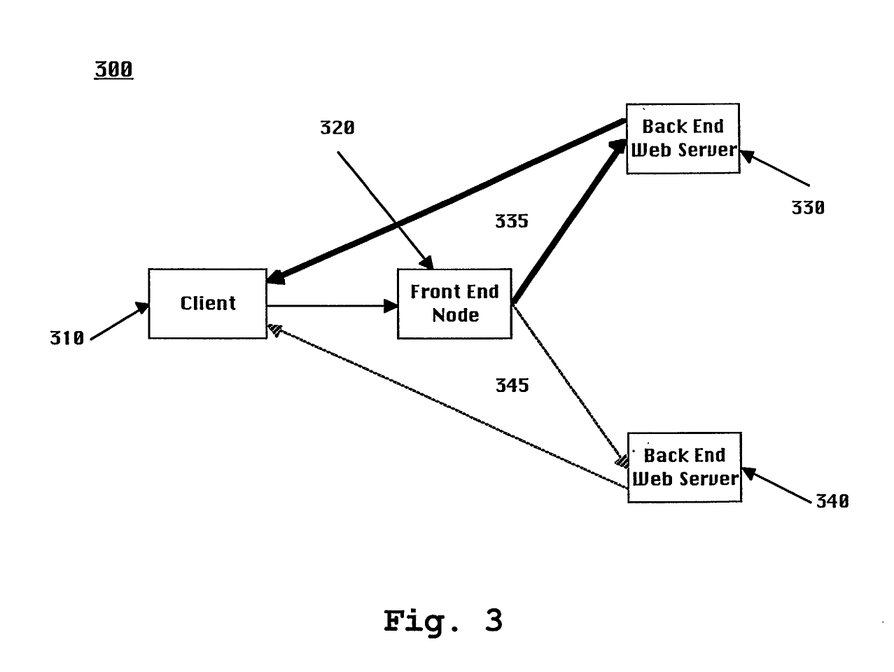

The TCP frequent-handoff mechanism enables the forwarding of back-end web server responses directly to the clients without passing through the front-end node. FIG. 3 illustrates an exemplary network 300 implementing the content-aware request distribution for a TCP frequent-handoff design, in accordance with one embodiment of the present invention.

The main idea behind the TCP frequent-handoff mechanism is to migrate the created TCP state from the distributor in the front end node 320 to the back-end web servers (e.g., 330 or 340). The TCP frequent-handoff protocol supports creating a TCP connection at the back-end web server without going through the TCP three-way handshake with the client. Similarly, an operation is required that retrieves the state of an established connection and destroys the connection state without going through the normal packet exchange required to close a TCP connection at the front-end node. Once the connection is handed off to back-end web server, the front-end node must forward packets from the client to the selected back-end web server.

The TCP frequent-handoff mechanism allows for response packets from the back-end web server to be sent directly to the client in a communication path that does not include the front-end node. For example, communication path 335 illustrates how a web request is sent from the front-end to the back-end web server. After the web request is processed, path 335 shows the response packet going directly from the back-end web server to the client 310. Also, the front-end node can access many back-end web servers for servicing web requests. Communication path 345 shows another web request flow path where response packets from back-end web server 340 are sent directly to the client 310.

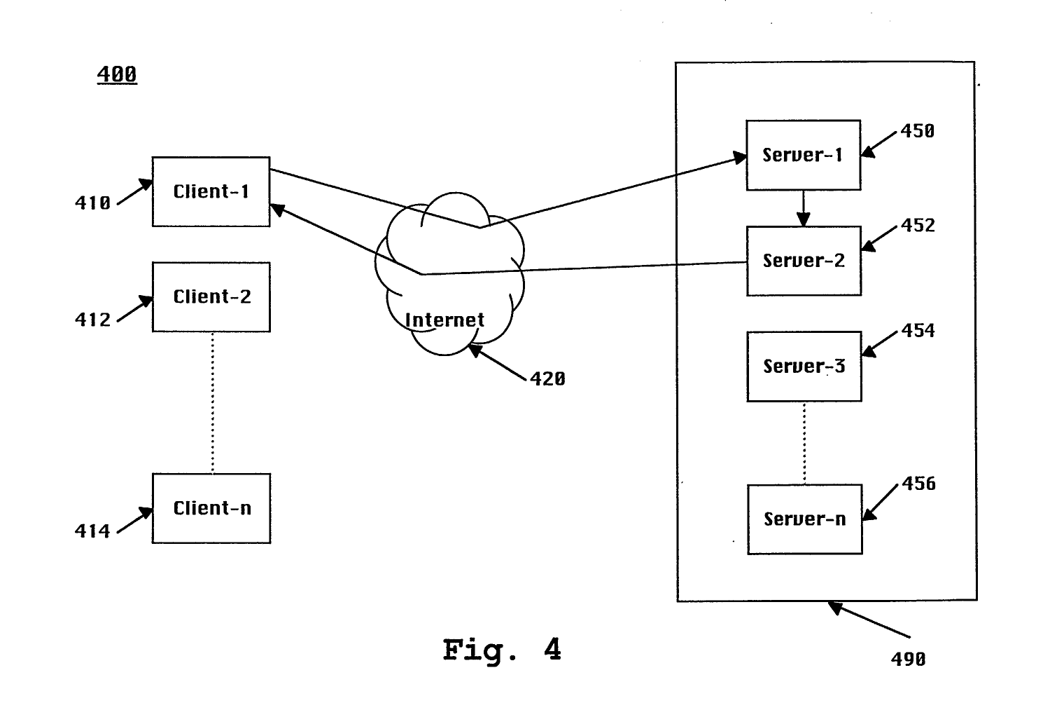

The difference in the response flow route for the TCP frequent-handoff mechanism allows for substantially higher scalability. For example, a network architecture 400 that implements the TCP frequent-handoff mechanism is shown in FIG. 4. Embodiments of the present invention consider a web cluster in which the content-aware distribution is performed by each node in a web cluster. Thus, each server in a cluster may forward a request to another node based on the request content using the TCP frequent-handoff mechanism.

The architecture 400 is illustrative of content-aware request distribution (CARD) architectures where the distributor is co-located with the web server. CARD Architectures implementing a Locality-Aware Request Distribution (LARD) policy when distributing web requests allow for increased scalability of the system. The LARD policy is outlined in a paper by Pai et al. titled: Locality-Aware Request Distribution in Cluster-Based Network Servers, Proceedings of the 8th International Conference on Architectural Support for Programming Languages and Operating Systems (ASPLOS VIII), ACM SIG PLAN, 1998, pp. 205-216. This is especially true when the system logically partitions documents among the cluster servers/nodes by optimizing the usage of the overall cluster RAM memory. This enables different requests for a particular document to be served by the same cluster node. This node most likely has the requested file in its RAM memory.

FIG. 4 also is illustrative of the traffic flow between clients and a web cluster defined by the web server-1 450, web server-2 452, web server-3 454, on up to web server-n 456. Network 400 also includes client-1 410, client-2 412, on up to client-n 414. The clients are coupled to the web cluster via the Internet 420.

The Internet 420 provides the network for passing traffic from each of the clients to the web cluster. For simplicity, it is assumed that the clients directly contact the distributor at the front-end node, for instance via a round-robin DNS mechanism. For example, client-1 410 sends a request to server-1 450 through the Internet 420. Server-1 450 acts as the front-end node in this case. After the front-end node 450 establishes the connection with the client 410, and the request distribution decision is made, the established connection is handed off to the selected back-end web server (web server-2 452) to service the request. The TCP state, related to the established connection, is migrated from the front-end node to the selected back-end web server. The main benefit of TCP frequent-handoff mechanism is that the back-end web server can send response packets directly to the client without routing outgoing packets back through the front-end node 450.

Streams-Based TCP/IP Implementation

Embodiments of the present invention utilize a STREAMS-based TCP/IP implementation that offers a framework for designing the TCP frequent-handoff mechanism as plug-in modules in the TCP/IP stack. The STREAMS modules provide the advantage of better portability. Also, the STREAMS-based modules are relatively independent of the original TCP/IP modules. In other words, STREAMS-based TCP frequent-handoff modules do not change any data structures or field values maintained by the original TCP/IP modules. Further, all the interactions between TCP frequent-handoff modules and the original TCP/IP modules are messaged based, such that, no direct function calls are made. This enables maximum portability, so that designed TCP frequent-handoff modules can be ported to other STREAMS-based TCP/IP operating systems very quickly.

Another advantage provided by the STREAMS-based modules is increased flexibility within the operating system. The TCP frequent-handoff modules may be dynamically loaded and unloaded as dynamically loadable kernel modules (DLKM) without service interruption. Improvements to the handoff mechanism are easily inserted as new TCP frequent-handoff modules into the kernel of an operating system without modifying the operating system.

Also, the STREAMS-based modules allow for application transparency. The TCP frequent-handoff mechanism operates at the kernel level within an operating system without any application layer involvement. Thus, no modifications at the application layer is necessary to perform TCP handoff. This is a valuable feature for applications where no source code is available.

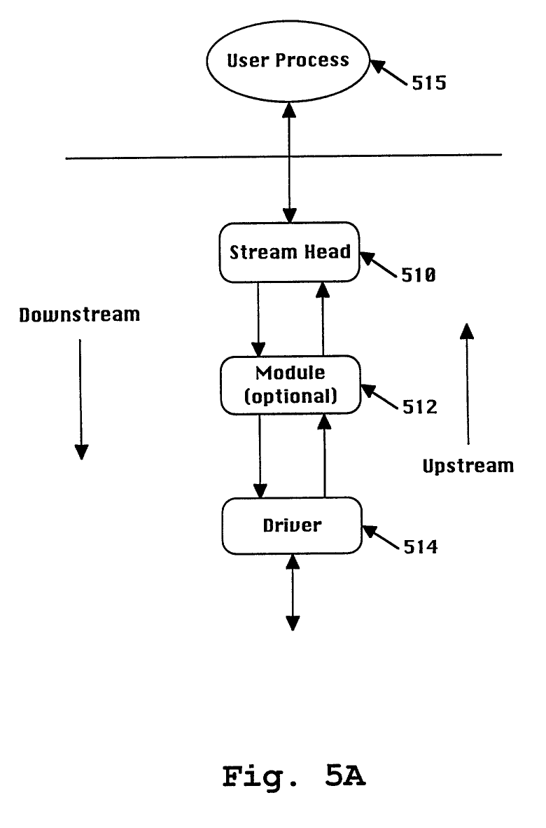

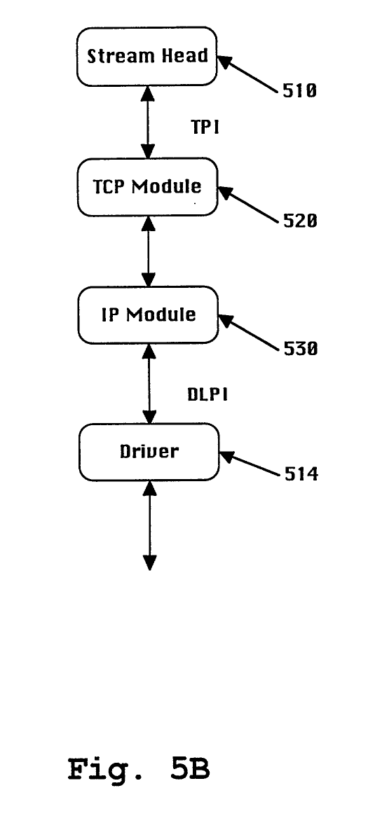

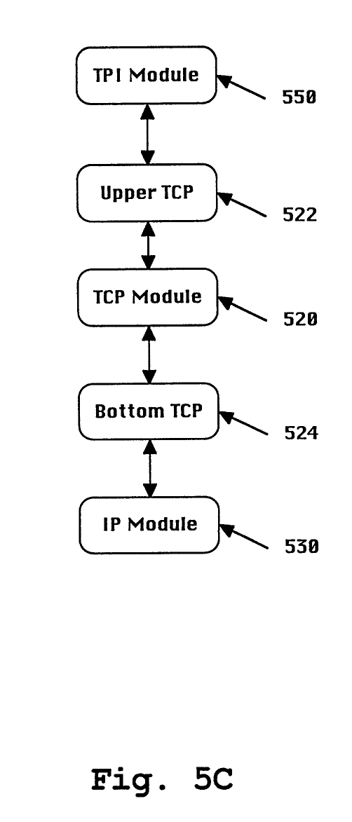

FIG. 5A illustrates a block diagram of a STREAMS-based modular framework for developing the TCP frequent-handoff mechanism, in accordance with one embodiment of the present invention. Each stream generally has a stream head 510, a driver 514, and multiple optional modules 512 between the stream head 510 and the driver 514. These modules 512 exchange information through messages. Messages can flow in the upstream direction or the downstream direction.

Each module 512 has a pair of queues: a write queue and a read queue. When a message passes through a queue, the routine for this queue is called to process the message. The routine can drop a message, pass a message, change the message header, or generate a new message.

The stream head 510 is responsible for interacting with the user processes 515. The stream head 510 accepts requests from the user processes 515, translates them into appropriate messages, and sends the messages downstream. The stream head 510 is also responsible for signaling to the user processes module 515 when new data arrives or some unexpected event happens.

FIG. 5B illustrates a block diagram of the standard STREAMS-based modules used for TCP/IP STREAMS-based implementation, in accordance with one embodiment of the present invention. A transport provider interface (TPI) specification defines the message interface between the TCP module 520 and the stream head module 510. A data link provider interface (DLPI) specification defines the message interface between driver module 514 and the IP module 530. These two specifications, TPI and DLPI, can be implemented in individual STREAMS modules and define the message format, valid sequences of messages, and semantics of messages exchanged between these neighboring modules.

For example, when the TCP module 520 receives a SYN request for establishing the HTTP connection, the TCP module 520 sends a “T_CONN_IND” message upstream. Under the TPI specification, the TCP module 520 should not proceed until it gets the response from the application layer. However, in order to be compatible with Berkeley Software Distribution (BSD) implementation-based applications, the TCP module 520 continues the connection establishment procedure with the client. When the application decides to accept the connection, it sends the “T_CONN_RES” downstream on the listen stream. It also creates another stream to accept this new connection, and the TCP module 520 attaches a TCP connection state to this new stream. Data exchange continues on the accepted stream until either end closes the connection.

Web Site Cluster Design for a Frequent-Handoff Architecture

As discussed previously, three main components comprise a web server cluster configuration in supporting a content-aware request distribution strategy: a dispatcher, a distributor, and a web server. The dispatcher implements the request distribution strategy and decides which web server will be processing a given request. The distributor interfaces with the client and implements the TCP handoff in order to distribute the client requests to a specific web server. The web server processes the client requests, or HTTP requests.

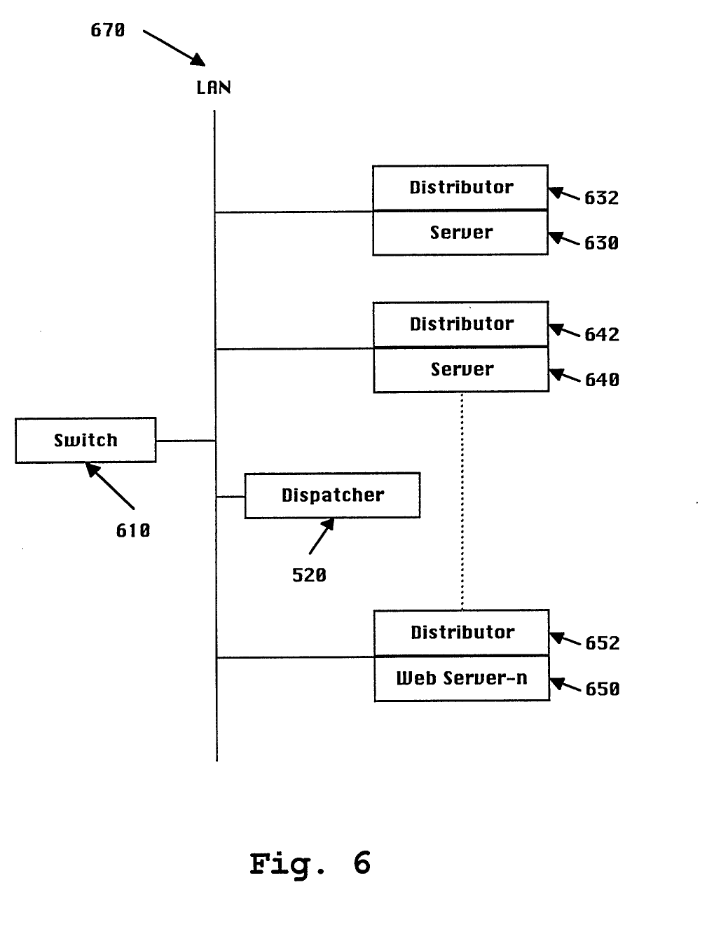

FIG. 6 shows a cluster architecture 600 that supports a network architecture implementing a TCP frequent-handoff design, in accordance with one embodiment of the present invention. Web servers 630, 640, on up to web server-n 650 are connected by a local area network 670. In this cluster architecture 600, the distributor components are co-located with the web server components, while the dispatcher component 620 is centralized. For example, a distributor component 632 is co-located with the web server-1 630. Correspondingly, a distributor component 642 is co-located with web server-2 640, and distributor component 652 is co-located with web server-n 650. Cluster architecture 600 is defined as a content-aware request distribution (CARD) architecture.

In the CARD architecture as illustrated in FIG. 6, the switch in front of the web cluster components (web servers 630, 640, and 650) can be a simple local area network (LAN) switch or a L4 level load balancer. Otherwise, for simplicity the clients could directly contact the distributor, for instance via Round-Robin DNS. The CARD architecture produces good scalability properties.

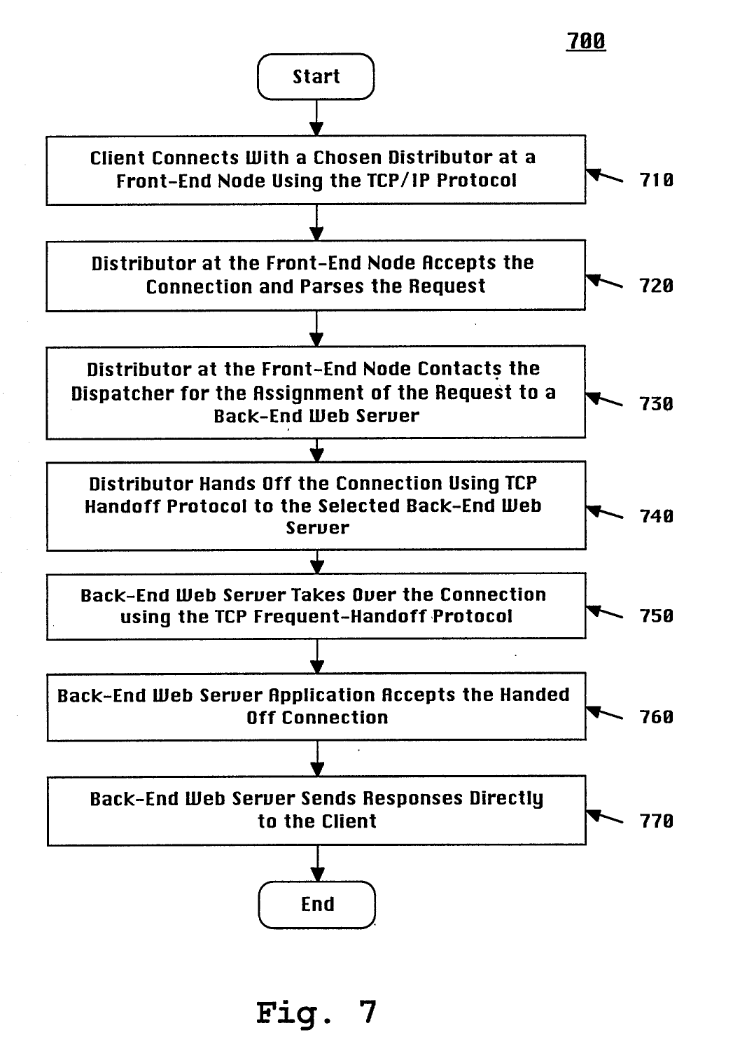

Flow chart 700, of FIG. 7, illustrates a method for processing a typical client request in a TCP frequent-handoff design, in accordance with one embodiment of the present invention. As shown in step 710, a client web browser uses the TCP/IP protocol to connect to a chosen distributor. As shown in step 720, the distributor component accepts the connection and parses the request. As shown in step 730, the distributor contacts the dispatcher for the assignment of the request to a back-end web server that is not co-located with the distributor. Since the CARD architecture (e.g., architecture 600) utilizes a centralized dispatcher, in a typical configuration, the dispatcher module resides on a separate node, such as dispatcher 620 in FIG. 6 to avoid bottlenecks in the system.

As shown in step 740 of FIG. 7, the distributor hands off the connection using the TCP frequent-handoff protocol to the back-end web server that was chosen by the dispatcher. As shown in step 750, the back-end web server takes over the connection using the hand-off protocol. As shown in step 760, the server application at the back-end web server accepts the created connection. As shown in step 770, the back-end web server sends the response directly to the client.

The specifics of this cluster architecture is that each node in a cluster has the same functionality. As such, each node combines the function of distributor and a web server. In other words, each node can act as a front-end node and/or a back-end web server in providing TCP frequent-handoff functionality. For each node, in the TCP frequent-handoff architecture, most of the HTTP requests will be processed remotely from the node accepting the connections. As such, TCP handoffs occurs relatively frequently. Under such a usage pattern, the goal for the frequent-TCP handoff design and implementation is to serve the remote requests as quickly as possible.

Modular TCP Frequent-Handoff Design Architecture

The TCP frequent-handoff design is optimized to minimize the TCP handoff procedures for remote processing of web requests. While local processing of web requests may require additional steps that are necessary, the TCP frequent-handoff mechanism is optimized to receive the web request at the front-end node and then migrate the TCP states.

The TCP frequent-handoff mechanism enables forwarding of responses from the back-end web server node directly to the client without passing through the distributing front-end node, in accordance with one embodiment of the present invention. In the CARD architecture (e.g., FIG. 6), each node performs both front-end and back-end functionality. Also, the distributor is co-located with web server. For definition, the distributor-node accepting the original client connection request is referred as front-end (FE) node. In case the request has to be processed by a different node, the remotely located node that receives the TCP handoff request is referred to as the back-end (BE) web server.

Two new modules are introduced to implement the functionality of TCP handoff as shown in FIG. 5C, in accordance with one embodiment of the present invention. According to the relative position in the existing TCP/IP stack, an upper TCP (UTCP) module 522 is introduced above the original TCP module 520 in the TCP/IP protocol stack. The module right under the TCP module 522 is the bottom TCP (BTCP) module 524. These two newly introduced modules provide a wrapper around the current TCP module 520.

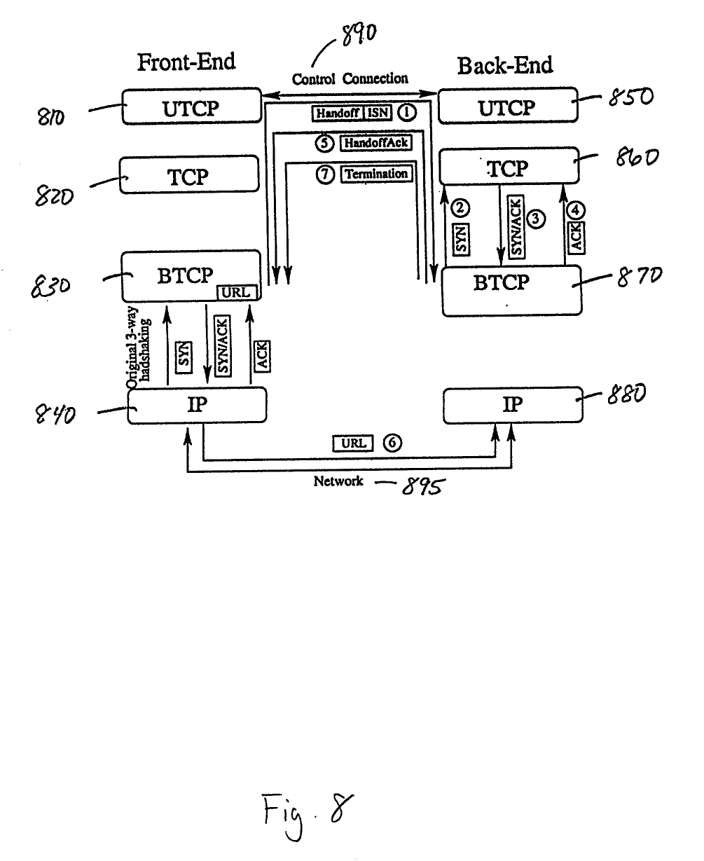

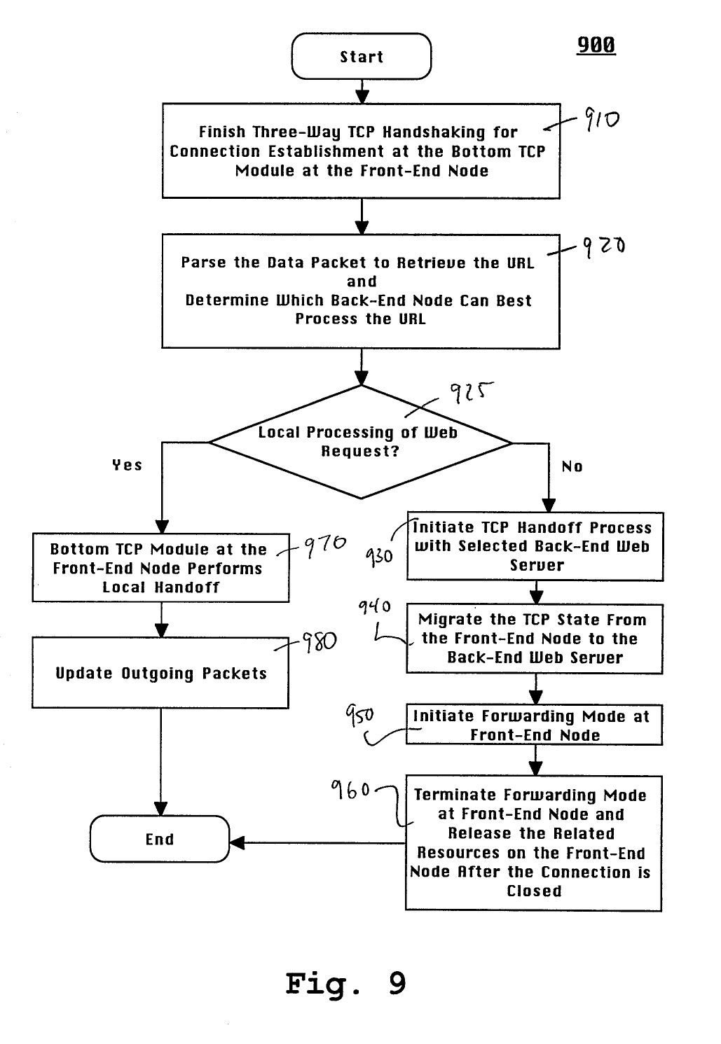

FIG. 8 is a block diagram of the remote request processing flow for a TCP frequent-handoff procedure in a network 800 between a front-end node and a back-end web server, in accordance with one embodiment of the present invention. The network 800 can be part of a larger network cluster comprising multiple server computers. Every node or server computer in the web cluster is homogeneously structured in order to implement the TCP frequent-handoff mechanism. Each node can operate as a front-end server node that receives a web request, or as a remotely located back-end web server that receives a forwarded web request for processing.

The TCP frequent-handoff modules of the front-end node are similar in structure to that illustrated in FIG. 5C and include the following: a UTCP_{FE} module 810, a TCP_{FE} module 820, a BTCP_{FE} module 830, and an IP_{FE} module 840. The TCP frequent-handoff modules of the selected back-end server are also similar in structure to that illustrated in FIG. 5C and include a UTCP_{BE} module 850, a TCP_{BE} module 860, a BTCP_{BE} module 870, and an IP_{BE} module 880.

A reliable control connection that provides a persistent communication channel (control channel 890) couples both UTCP_{FE} module 810 and UTCP_{BE} module 850. This special communication channel is needed to initiate the TCP frequent-handoff between the front-end node and the back-end web server. The control connection 890 is a pre-established persistent connection set up during the cluster initialization. Each node is connected to all other nodes in the cluster via the control connection 890. Any communication between the BTCP_{FE} module 830 and the BTCP_{BE} module 870 goes through the control connection 890 by sending the message to the corresponding UTCP module first (see FIG. 8). In another embodiment, control channel 890 is a User Datagram Protocol (UDP) connection.

A network connection 895 provides further communication between nodes in the web cluster, including the front-end node and back-end web server as described in FIG. 8. The network connection 895 can be over a LAN network, a WAN network, or any suitable communication network including the Internet.

For remotely processed requests, there are six logical steps to perform TCP frequent-handoff of the HTTP request in the CARD architecture. Flow chart 800, of FIG. 8, illustrates a method for remotely processing a typical client request following the six logical steps for a TCP frequent-handoff architecture, in accordance with one embodiment of the present invention. Flow chart 900 also provides a method for locally processing the client request.

As shown in step 910, the present embodiment in the first step finishes the three-way TCP handshaking protocol for connection establishment between the client browser and the bottom TCP (BTCP_{FE}) module at the front-end node. It is inefficient to establish a TCP connection with the TCP (TCP_{FE}) module at the front-end node and then free the connection the majority of the time. Therefore, connection setup (the original three-way handshaking) is reimplemented by the BTCP_{FE} module to trigger the client to send the URL. In addition, the BTCP_{FE} module has better control over TCP options.

As shown in step 920, the present embodiment in the second step makes the routing decision to select which back-end web server can best process the request. The BTCP_{FE} module parses the first data packet from the client and retrieves the requested URL. Thereafter, the BTCP_{FE} module examines the content of the URL in order to determine which back-end web server, a selected back-end web server, can best process the requested URL.

As shown in step 925, flow chart 900 proceeds to step 930 if the URL is processed remotely. For remote processing of the URL, in the third logical step, as shown in step 930 of the present embodiment, a TCP frequent-handoff process is initiated with the selected back-end web server. The connection from the client to the BTCP_{FE} module must be extended from the front-end node to the selected back-end web server. This is accomplished by migrating the TCP state of the BTCP_{FE} module to the back-end web server in step 940.

After the BTCP_{FE} module decides to handoff the connection, the BTCP_{FE} module sends a handoff request to the bottom TCP (BTCP_{BE}) module at the selected back-end web server over the control channel (see FIG. 8, step 1). However, packets are not shipped along the persistent connection in the handoff request. Instead, the BTCP_{FE} module may gather necessary information (e.g., the Initial Sequence Number (ISN), etc.) from the connection establishment packets and include these in the handoff request packet. Thereafter, the BTCP_{BE} module may reconstruct these packets from the information provided in the handoff request, and reconstruct the connection packets locally at the selected back-end web server (see FIG. 8, steps 2-4).

In the fourth step, as shown in step 940 of the present embodiment, a TCP state is migrated from the front-end node to the selected back-end web server. An acknowledgment is returned to the BTCP_{FE} module (see FIG. 8, step 5) after successful TCP state migration.

In the fifth step, as shown in step 950 of the present embodiment, the data packets received at the front-end node from the client browser are forwarded to the selected back-end web server. In the sixth step, as shown in step 960 of the present embodiment, the forwarding mode at the front-end node is terminated. Correspondingly, the related resources at the front-end node are released after the connection is closed.

Alternatively, if it is determined, in step 920, that the best web server to process the URL is the local server, then flow chart 900 proceeds to step 970. After the BTCP_{FE} module discovers that the requested URL should be served locally, then the BTCP_{FE} module simply does a local handoff. The BTCP_{FE} module reconstructs the connection establishment packets to the upstream TCP_{FE} module at the front-end node to create the necessary state. The BTCP_{FE} module also performs TCP initial sequence number and TCP checksum updates for outbound traffic from this connection, as is shown in step 980.

The original TCP connection establishment can be done in two different modules: either in the operating system TCP module or the BTCP module. When the TCP module is used to establish the connection with the client, the initial sequence number is correct so local request may respond to the client directly without any packet header manipulation.

If the BTCP module is used, the initial sequence number used by the TCP module and BTCP module might be different because of the local handoff. In this case, the BTCP module has to update the initial sequence number and TCP checksum for every outgoing packet for local requests. In the TCP frequent-handoff design, remote request processing is improved with an additional small penalty for processing local requests.

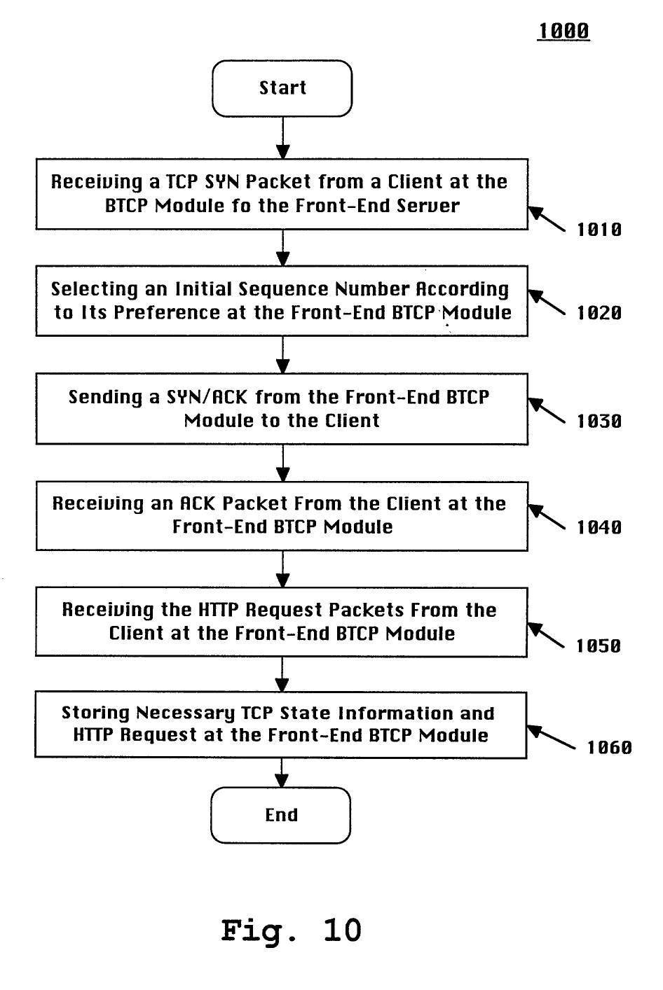

FIG. 10 is a flow chart 1000 illustrating steps in a method for establishing a connection between a client and a front-end node, in accordance with one embodiment of the present invention. The BTCP_{FE} module implements the connection setup function at the front-end node. Before the requested URL is sent by the client to make a routing decision, the connection has to be established between the client and the front-end server. Packets are exchanged to establish the connection. After the connection is established, a data packet containing the requested URL is passed from the client to the front-end node.

Since internet traffic follows a TCP/IP communication protocol, a TCP SYN packet is sent from the client to the front-end node. The front-end node is part of a web cluster and is selected by various means such as by a switching mechanism as illustrated in FIG. 6, a load balancer, or by DNS Round Robin, etc., as discussed previously. The web cluster can comprise a network architecture including a plurality of web servers, such as the network architectures shown in FIGS. 4 and 6.

The SYN packet arrives at the BTCP_{FE} module in step 1010 of flow chart 1000, in accordance with one embodiment of the present invention. The SYN packet is sent to establish a communication session for the purposes of obtaining information associated with the requested URL that is contained in the web cluster. The BTCP_{FE} module finishes the connection setup with the client.

As shown in step 1020 of flow chart 1000, the BTCP_{FE} module selects an initial sequence number (ISN) according to its preference. In step 1030, the BTCP_{FE} sends a SYN/ACK packet with the initial sequence number that, among other variables, indicates the initial TCP state of the BTCP_{FE} module in association with the communication session.

As shown in step 1040 of flow chart 1000, the BTCP_{FE} module receives an ACK packet from the client. It is at the point that the connection is established between the client and the front-end node. During this process, the BTCP_{FE} module emulates the TCP state transition and changes its TCP state accordingly.

As shown in step 1050 of flow chart 1000, after the connection is established, the client sends data packets, which includes the URL, to the BTCP_{FE} module. The BTCP_{FE} module retrieves the URL, examines its content and selects the best web server, a selected back-end web server, to process the HTTP request. For remote processing, all of the above activities in flow chart 1000 occur without the involvement of the TCP_{FE} module in the original operating system at the front-end node.

As shown in step 1060 of flow chart 1000, the BTCP_{FE} module stores necessary information from the connection establishment packets in order to migrate the TCP state from the front-end node to the selected back-end web server, and to reconstruct the TCP/IP connection establishment packets. This information may include the HTTP request, ISN of the BTCP_{FE} module, etc. In another embodiment, the original connection establishment packets may also be stored.

In a TCP frequent-handoff network architecture, a special communication channel is needed to initiate the TCP handoff between the front-end node and the selected back-end web server. The control connection is a pre-established persistent connection as illustrated in FIG. 8 by control connection 890, and is created during the web cluster initialization. Each node is coupled to all other nodes in the cluster.

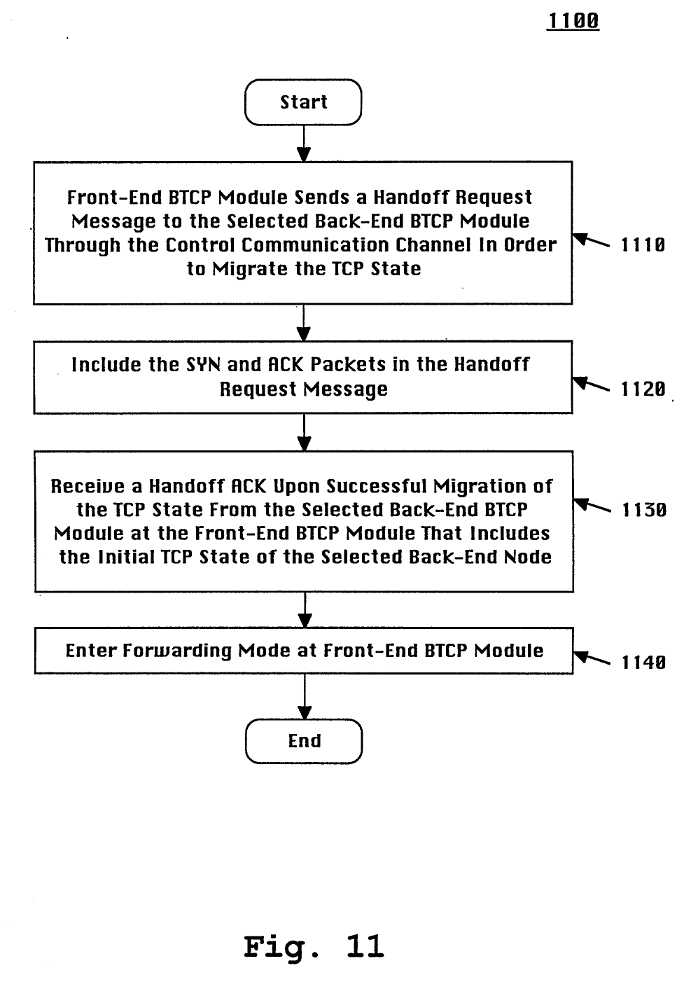

FIG. 11 is a flow diagram that in conjunction with FIG. 8 illustrate steps in a method for initiating and handing off the TCP state from the perspective of the BTCP_{FE} module at the front-end node, in accordance with one embodiment of the present invention.

As shown in step 1110, a TCP frequent-handoff request message is sent over the control channel by the BTCP_{FE} module to initiate the handoff process with the selected back-end web server (see FIG. 8, step 1) using a proprietary TCP frequent-handoff protocol.

As shown in step 1120, the handoff request message may include necessary information so that the BTCP_{BE} module at the selected back-end web server can reconstruct the connection setup packets locally at the selected back-end web server in the correct TCP state. This information may include the initial sequence number (ISN) of the BTCP_{FE} module associated with the communication session and others. In another embodiment, this information may include the original SYN and ACK connection packets from the client. The BTCP_{BE} module uses the information contained in the handoff request message to migrate the associated TCP state of the front-end node.

As shown in step 1130 of flow chart 1100, if the BTCP_{BE} module successfully migrates the state, an acknowledgment is returned (see FIG. 8, step 5) to the BTCP_{FE} module using the same proprietary TCP frequent-handoff protocol over the control channel. Thereafter, the BTCP_{FE} module enters into a forwarding mode.

Once a back-end web server is selected to service the HTTP request, the connection for the communication session established by the HTTP request must be extended or handed off to the selected back-end web server. However, it is difficult to retrieve the current state of a connection at the front-end node, transfer this state to the selected back-end server, and duplicate this TCP state at the TCP module at the back-end web server. For example, it is difficult to retrieve the TCP state out of the black box of the TCP_{FE} module. Even if this could be done, it is very difficult to physically replicate this TCP state at the TCP (TCP_{BE}) module at the selected back-end web server. The TPI specification does not support schemes by which a new half-open TCP connection with a predefined state can be opened.

On the other hand, one embodiment of the present invention creates the half-open connection by reconstructing or replaying the original connection packets to the TCP_{BE} module at the selected back-end web server. In a sense, the BTCP_{BE} module acts as a client to the TCP_{BE} module (see FIG. 8).

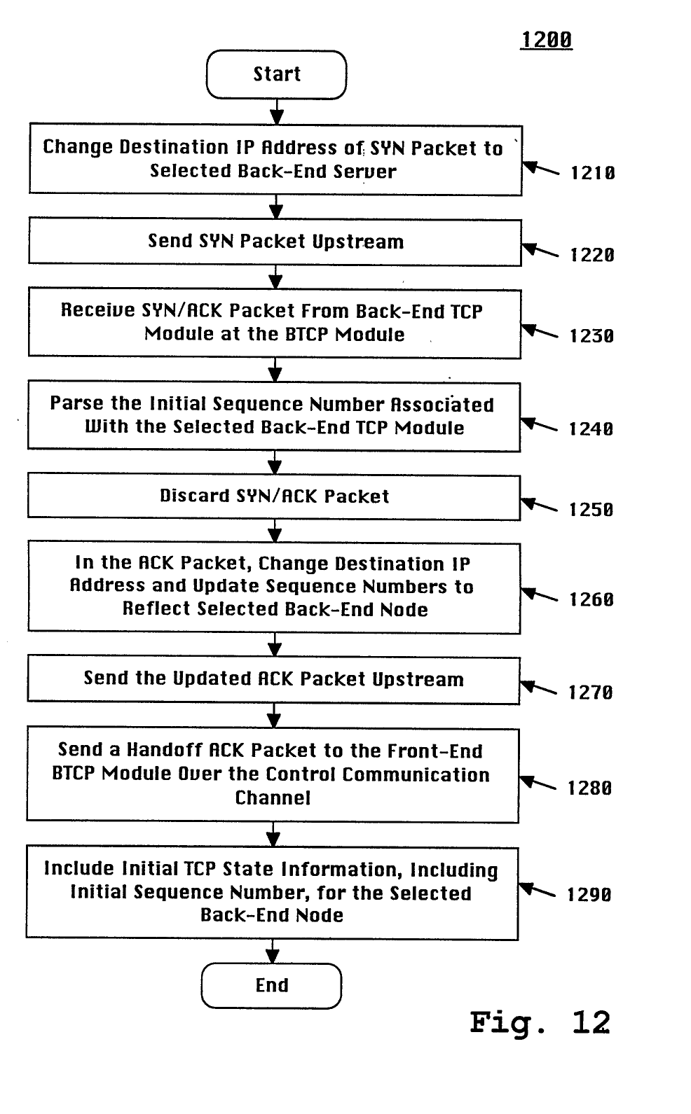

FIG. 12 is a flow chart of steps that in conjunction with FIG. 8 illustrate steps in a method for extending the connection setup to a selected back-end server from the perspective of the BTCP_{BE} module, in accordance with one embodiment of the present invention.

In step 1210 of flow chart 1200, the BTCP_{BE} module reconstructs the connection establishment packets using TCP state information from the BTCP_{FE} module. Additionally, the BTCP_{BE} module changes the destination IP address of SYN packet to the IP address of the selected back-end web server (see FIG. 8, step 2). In step 1220, the BTCP_{BE} module sends the SYN packet upstream (see FIG. 8, step 2).

The TCP_{BE} module at the selected back-end web server responds with a TCP SYN/ACK message (FIG. 8, step 3). The BTCP_{BE} parses the SYN/ACK message for the initial sequence number associated with the TCP_{BE} module, in step 1240. In step 1250, the BTCP_{BE} records the initial sequence number of the TCP_{BE} and discards the SYN/ACK packet.

In step 1260, the BTCP_{BE} module reconstructs the original ACK packet from the client. Additionally, the BTCP_{BE} module updates the header of the ACK packet header properly, such that the destination IP address is changed to that of the selected back-end web server. Also, the TCP sequence numbers are updated to reflect that of the selected back-end web server (e.g., the TCP sequence number, and the TCP checksum). In step 1270, the BTCP_{BE} sends the updated ACK packet upstream (FIG. 8, step 4).

In step 1270, the BTCP_{BE} module sends a handoff acknowledgment message back to the BTCP_{FE} module over the control connection using a proprietary TCP frequent-handoff protocol. This acknowledgment packet notifies the front-end node that the TCP state was successfully migrated. Included within the handoff acknowledgment is the initial TCP state information for the selected back-end web server. Specifically, the initial sequence number for the TCP_{BE} module is included.

After handoff is processed successfully, the BTCP_{FE} module enters a forwarding mode. The BTCP_{FE} module forwards all the pending data in BTCP_{FE} module, which includes the data packets containing the requested URL (FIG. 8, step 6) over the communication network, such as network 895 of FIG. 8. All subsequent data packets are forwarded on this connection until the forward session is closed.

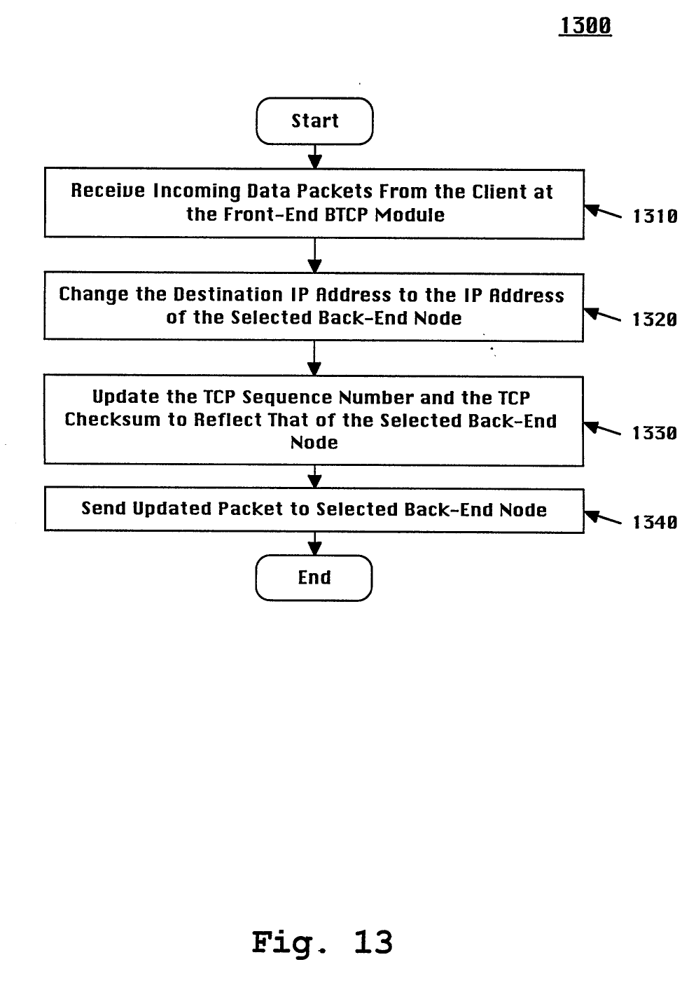

FIG. 13 is a flow chart 1300 illustrating steps in a method for forwarding incoming message traffic from the front-end node to the selected back-end web server, in accordance with one embodiment of the present invention. In step 1310, the BTCP_{FE} module receives incoming data packets from the client.

During the data forwarding step, BTCP_{FE} updates (corrects) the fields in the packet to reflect the selected back-end web server. In step 1320, the destination IP address is changed to the IP address of the selected back-end web server. In step 1330, the TCP sequence number, and the TCP checksum are updated to reflect that of the selected back-end web server. Then in step 1340, the BTCP_{FE} forwards packets downstream to the selected back-end web server through the network (see FIG. 8, step 6), such as the network 895 of FIG. 8.

Packets may be forwarded to the selected server on top of the IP layer, in the IP layer, or under the IP layer, depending on the cluster configuration and the ratio between the local traffic and forwarding traffic. While the BTCP_{FE} module may forward the packets on top of the IP layer, similar functionalities can be achieved by inserting a module on top of device driver.

When the BTCP_{FE} module is implemented on top of the device driver, and all the back-end web servers are located on the same LAN (as in the previously described partition-based proxy application), it is possible for a cluster to have a virtual IP address. In this case, each back-end web server is uniquely identified by a MAC address, and the packet is forwarded by filling in the right MAC address. This avoids Network Address Translation (NAT) on the front-end node and the NAT on the back-end web server for outgoing traffic. Upon receiving the DLPI message from the device driver, the BTCP_{FE} module changes the DLPI message format and destination MAC address and sends the message downstream.

When the forwarding packets may need to traverse a router or across a wide area network (WAN), the destination of a packet may be changed to the selected server's IP address and a proprietary protocol may be developed to carry the packet's original IP address to the selected server. This enables the response packet's source IP address to be updated accordingly. In that case, the BTCP_{FE} module updates the packet's IP address to the selected server's IP address, and sends the packet upstream. The IP (IP_{FE}) module at the front-end node forwards the packet according to its routing tables to the selected back-end web server. The BTCP_{BE} module updates the initial sequence number and TCP checksum.

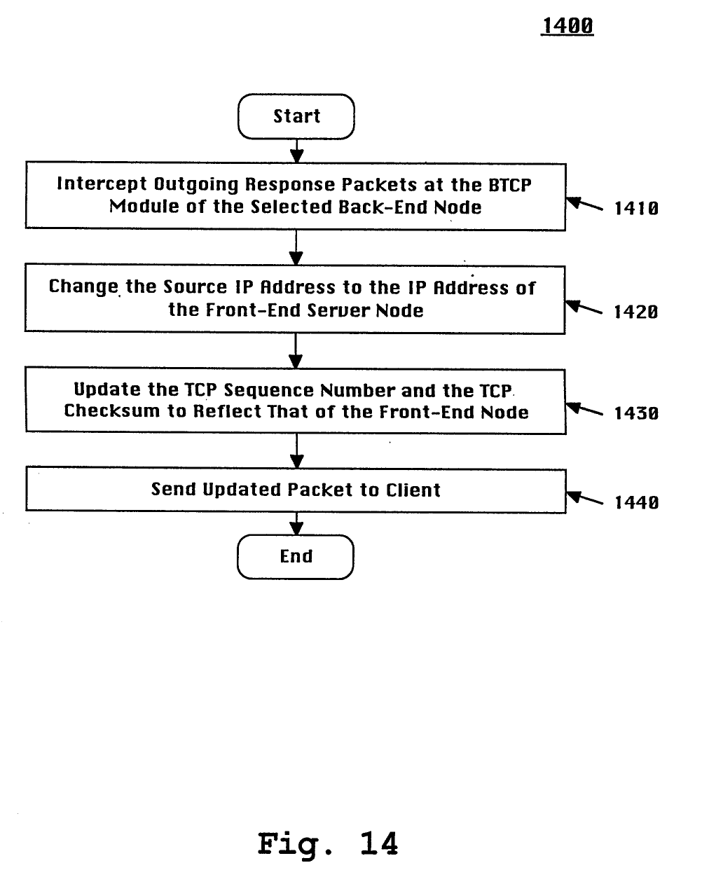

FIG. 14 is a flow diagram illustrating steps in a method for sending response packets from the selected back-end web server directly to the client, in accordance with one embodiment of the present invention. The BTCP_{BE} module updates (corrects) fields in the packet to reflect that of the front-end node.

In step 1410 of flow chart 1400, the BTCP_{BE} module intercepts the outgoing response packets. In step 1420, the BTCP_{BE} module changes the source address to the IP address of the front-end node. In step 1430, the BTCP_{BE} module updates the TCP sequence number and the TCP checksum to reflect that of the front-end node. After that, the BTCP_{BE} module sends the packet downstream to the client in step 1440.

In order to free the front-end forward session successfully and robustly, either the back-end or the front-end node has to observe the two-way TCP control traffic. In this frequent handoff design, the BTCP_{BE} module sees the two-way traffic and knows the status of the TCP connection. Thus, the BTCP_{BE} module is able to send notification to the front-end node upon termination of the connection.

The connection termination of the communication session should free states at the back-end and front-end nodes. The data structures at the back-end web server are closed by the STREAMS mechanism. The BTCP_{BE} monitors the status of the handoff connection and notifies the BTCP_{FE} upon the close of the handoff connection in the TCP_{BE} (see FIG. 8, step 7), in accordance with one embodiment of the present invention. This communication occurs over the control channel. The BTCP_{FE} releases the resources related to the forwarding mechanism after receiving such a notification.

While the methods of embodiments illustrated in flow charts 700, 900, 1000, 1100, 1200, 1300, and 1400 show specific sequences and quantity of steps, the present invention is suitable to alternative embodiments.

Embodiments of the present invention, a method and system for a modular transmission control protocol (TCP) frequent-handoff design in a STREAMS-based transmission control protocol Internet protocol (TCP/IP) implementation, is thus described. While the present invention has been described in particular embodiments, it should be appreciated that the present invention should not be construed as limited by such embodiments, but rather construed according to the below claims.

What is claimed is:

1. In a communication network, a method of TCP state migration comprising the steps of:
a) establishing a TCP/IP communication session between a client computer and a first bottom TCP (BTCP) module located below a first TCP module in a first operating system at a front-end node, said front end node part of a plurality of web server nodes that form a web server cluster containing information, said TCP/IP communication session established for the transfer of data contained within said information;
b) handing off said TCP/IP communication session from said first BTCP module to a selected back-end node over a persistent control channel; and
c) migrating a first TCP state of said first BTCP module to said selected back-end node, and sending a second TCP state of said selected back-end node to said first BTCP module over said control channel.

2. The method as described in claim 1, wherein said step a) at said first BTCP module comprises the steps of:
a1) receiving a TCP/IP SYN packet from said client;
a2) selecting a first initial sequence number (ISN) for said first BTCP module that is associated with said TCP/IP communication session, said first ISN associated with a first TCP state of said first BTCP module;
a3) sending a TCP/IP SYN/ACK packet to said client;
a4) receiving a TCP/IP ACK packet from said client at said first BTCP module;
a5) receiving a HTTP request associated with said TCP/IP communication session; and
a6) storing said HTTP request and connection parameters associated with said TCP/IP SYN and TCP/IP ACK packets at said front-end node.

3. The method as described in claim 2, wherein said step b) at said first BTCP module comprises the steps of:
b1) examining content of said HTTP request;
b2) determining which of said plurality of web server nodes, a selected back-end node, can best process said HTTP request based on said content;
b3) sending a handoff request message to a second BTCP module located at said selected back-end node over said control channel, if said selected back-end node is not said front-end node, said second BTCP module located below a second TCP module in a second operating system at said selected back-end node;
b4) including said connection parameters in said handoff request;
b5) including a first initial TCP state information for said first BTCP module, including said first ISN in said message; and
b6) receiving a handoff acknowledgment message from said second BTCP module if said TCP/IP communication session is successfully handed off.

4. The method as described in claim 3, wherein said step c) at said second BTCP module comprises the further steps of:
c1) reconstructing said TCP/IP SYN packet using said connection parameters including changing a first destination IP address of said SYN packet to a second IP address of said selected back-end node;
c2) sending said TCP/IP SYN packet to said second TCP module;
c3) receiving a second TCP/IP SYN/ACK packet from said second TCP module;
c4) parsing a second initial TCP state from said second TCP/IP SYN/ACK packet, including a second ISN for said second TCP module, said second initial TCP state necessary for understanding said second TCP state for said second TCP module in said TCP/IP communication session;
c5) reconstructing said TCP/IP ACK packet using said connection parameters including changing a second destination IP address of said TCP/IP ACK packet to said second IP address;
c6) updating said TCP/IP ACK packet to reflect said second TCP state of said selected back-end node in said TCP/IP communication session;
c7) sending said TCP/IP ACK packet that is updated to said second TCP module; and
c8) sending a handoff acknowledgment message to said first BTCP module.

5. The method as described in claim 4, wherein said step c) further comprises the steps of:
c9) migrating said first initial TCP state to said second BTCP module over said control channel by including said first initial TCP state in said handoff request message, said first initial TCP state including said first ISN, such that said second BTCP module can calculate said first TCP state for said front-end node in said TCP/IP communication session; and
c10) sending said second initial TCP state of said selected back-end node to said first BTCP module by including said second initial TCP state in said handoff acknowledgment message, said second initial TCP state including said second ISN, such that said first BTCP module can calculate said second TCP state for said second TCP module in said TCP/IP communication session.

6. The method as described in claim 1, comprising the further steps of at said first BTCP module:
d) receiving incoming data packets from said client;
e) changing destination addresses of said incoming data packets to a second IP address of said selected back-end node;
f) updating TCP sequence numbers and TCP checksum in said data packets to reflect said second TCP state of said selected back-end node; and
f) forwarding said data packets to said selected back-end server computer.

7. The method as described in claim 1, comprising the further steps of:
d) intercepting outgoing response packets from said selected back-end node at a second bottom TCP module located below a second TCP module in a second operating system at said selected back-end node;
e) changing source addresses of said response packets to a first IP address of said first front-end node;
f) updating sequence numbers and TCP checksum in said response packets to reflect said first TCP state; and
g) sending said response packets to said client.

8. The method as described in claim 1, wherein said method is optimized for frequent TCP state handoffs.

9. The method as described in claim 1, comprising the further steps of:
d) monitoring TCP/IP control traffic for said TCP/IP communication session at a second BTCP module located below a second TCP module in a second operating system at said selected back-end node;
e) understanding when said TCP/IP communication session is closed at said second server computer;
f) sending a termination message to said first server computer over said control channel;
g) terminating said TCP/IP communication session at said front-end node; and
h) freeing data resources associated with said TCP/IP communication session at said front-end node.

10. The method as described in claim 1, wherein each node in said web cluster can perform as said front-end node and as said selected back-end node.

11. The method as described in claim 1, if said selected back-end node is said front-end node, comprising the further steps of:
sending a reconstructed TCP/IP SYN packet from said first BTCP module to said first TCP module;
receiving a TCP/IP SYN/ACK packet at said first BTCP module from said first TCP module;
parsing a third initial TCP state from said second TCP/IP SYN/ACK packet, said third initial TCP state associated with a third TCP state for said first TCP module in said TCP/IP communication session;
updating a reconstructed TCP/IP ACK packet to reflect said third TCP state;
sending said updated TCP/IP ACK packet to said first TCP module;
updating incoming data packets from said client at said first BTCP module to reflect said third TCP state, including TCP sequences numbers and TCP checksum; and
updating outgoing response packets from said TCP module to reflect said first TCP state, including TCP sequence numbers and TCP checksum.

12. The method as described in claim 1, wherein dynamically loadable modules, including said first BTCP module, in operating systems at both said front-end node and said selected back-end node, including said first operating system, implement a TCP handoff protocol that works within kernel levels of an existing TCP/IP protocol.

13. In a communication network, a method of TCP state migration comprising the steps of:
a) establishing a TCP/IP communication session between a client computer and a first bottom TCP (BTCP) module located below a first TCP module in a first operating system at a front-end node, said front end node part of a plurality of web server nodes that form a web server cluster containing information, said TCP/IP communication session established for the transfer of data contained within said information;
b) receiving a HTTP request associated with said TCP/IP communication session at said first BTCP module;
c) examining content of said HTTP request;
d) determining which of said plurality of web server nodes, a selected back-end node, can best process said HTTP request based on said content;
e) handing off said TCP/IP communication session from said first BTCP module to a selected back-end node over a persistent control channel;
f) migrating a first TCP state of said first BTCP module to said selected back-end node, and sending a second TCP state of said selected back-end node to said first BTCP module over said control channel;
g) forwarding incoming data packets received at said first BTCP module to said selected back-end node; and
h) sending outgoing response packets from said selected back-end node directly to said client; and
i) terminating said TCP/IP communication session at said front-end node and said selected back-end node when said TCP/IP communication session is closed.

14. The method as described in claim 13, wherein said step a) at said first BTCP module comprises the steps of:
a1) receiving a TCP/IP SYN packet from said client;
a2) selecting a first initial sequence number (ISN) for said first BTCP module that is associated with said TCP/IP communication session, said first ISN associated with a first TCP state of said first BTCP module;
a3) sending a TCP/IP SYN/ACK packet to said client;
a4) receiving a TCP/IP ACK packet from said client at said first BTCP module;
a5) receiving said HTTP request associated with said TCP/IP communication session from said client computer; and
a6) storing said HTTP request and connection parameters associated with said TCP/IP SYN and TCP/IP ACK packets at said front-end node.

15. The method as described in claim 14, wherein said step e) at said first BTCP module comprises the steps of:
e1) sending a handoff request message to a second BTCP module located at said selected back-end node over said control channel, if said selected back-end node is not said front-end node, said second BTCP module located below a second TCP module in a second operating system at said selected back-end node;
e2) including said connection parameters in said handoff request message;
e3) including a first initial TCP state information for said first BTCP module, including said first ISN in said handoff request message; and
e4) receiving a handoff acknowledgment message from said second BTCP module if said TCP/IP communication session is successfully handed off.

16. The method as described in claim 15, wherein said step f) at said second BTCP module comprises the further steps of:
f1) reconstructing said TCP/IP SYN packet including changing a first destination IP address of said TCP/IP SYN packet to a second IP address of said selected back-end node;
f2) sending said TCP/IP SYN packet that is reconstructed to said second TCP module;
f3) receiving a second TCP/IP SYN/ACK packet from said second TCP module;
f4) parsing a second initial TCP state from said second TCP/IP SYN/ACK packet, including a second ISN for said second TCP module, said second initial TCP state necessary for understanding said second TCP state for said second TCP module in said TCP/IP communication session;
f5) reconstructing said TCP/IP ACK packet including changing a second destination IP address of said TCP/IP ACK packet to said second IP address;
f6) updating said TCP/IP ACK packet to reflect said second TCP state of said selected back-end node in said TCP/IP communication session;
f7) sending said TCP/IP ACK packet that is reconstructed and updated to said second TCP module; and
f8) sending a handoff acknowledgment message to said first BTCP module.

17. The method as described in claim 16, wherein said step c) further comprises the steps of:
f9) migrating said first initial TCP state to said second BTCP module over said control channel by including said first initial TCP state in said handoff request message, said first initial TCP state including said first ISN, such that said second BTCP module can calculate said first TCP state for said front-end node in said TCP/IP communication session; and
f10) sending said second initial TCP state of said selected back-end node to said first BTCP module by including said second initial TCP state in said handoff acknowledgment message, said second initial TCP state including said second ISN, such that said first BTCP module can calculate said second TCP state for said second TCP module in said TCP/IP communication session.

17. The method as described in claim 13, comprising the further steps of at said first BTCP module:
j) receiving incoming data packets from said client;
k) changing destination addresses of said incoming data packets to a second IP address of said selected back-end node;
l) updating TCP sequence numbers and TCP checksum in said data packets to reflect said second TCP state of said selected back-end node; and
m) forwarding said data packets to said selected back-end server computer.

18. The method as described in claim 13, comprising the further steps of:
j) intercepting outgoing response packets from said selected back-end node at a second bottom TCP module located below a second TCP module in a second operating system at said selected back-end node;
k) changing source addresses of said response packets to a first IP address of said first front-end node;
l) updating sequence numbers and TCP checksum in said response packets to reflect said first TCP state; and
m) sending said response packets to said client.

19. The method as described in claim 13, comprising the further steps of:
j) monitoring TCP/IP control traffic for said TCP/IP communication session at a second BTCP module located below a second TCP module in a second operating system at said selected back-end node;
k) understanding when said TCP/IP communication session is closed at said second server computer;
l) sending a termination message to said first server computer over said control channel;
m) terminating said TCP/IP communication session at said front-end node; and
n) freeing data resources associated with said TCP/IP communication session at said front-end node.

20. The method as described in claim 13, if said selected back-end node is said front-end node, comprising the further steps of:
sending a reconstructed TCP/IP SYN packet from said first BTCP module to said first TCP module;
receiving a second TCP/IP SYN/ACK packet at said first BTCP module from said first TCP module;
parsing a third initial TCP state from said second TCP/IP SYN/ACK packet, said third initial TCP state associated with a third TCP state for said first TCP module in said TCP/IP communication session;
updating said TCP/IP ACK packet to reflect said third TCP state;
sending said updated TCP/IP ACK packet to said first TCP module;
updating incoming data packets from said client at said first BTCP module to reflect said third TCP state, including TCP sequences numbers and TCP checksum; and
updating outgoing response packets from said TCP module to reflect said first TCP state, including TCP sequence numbers and TCP checksum.

21. The method as described in claim 13, wherein each node in said web cluster can perform as said front-end node and as said selected back-end node, and said control channel allows for communication between all nodes for TCP state migration.

22. The method as described in claim 13, wherein said plurality of server computers is coupled together over a local area network in said communication network.

23. The method as described in claim 13, wherein said information is partitioned/partially replicated throughout each of said plurality of server computers.

24. A computer system comprising:
a bus;
a processor;
a memory coupled to said processor via said bus; and
a bottom TCP (BTCP) module comprising a dynamically loadable module that works within the kernel level of an existing TCP/IP protocol, wherein said memory contains instructions that when executed implement a method of TCP state migration between two nodes in a web server cluster, said web server cluster comprising a plurality of web server nodes, each of which comprising said computer system, said method optimized for frequent TCP state handoffs, said method comprising steps of:
a) establishing a TCP/IP communication session between a client computer and a first BTCP module located below a first TCP module in a first operating system at a front-end node, said front end node part of said plurality of web server nodes that contain information, said TCP/IP communication session established for the transfer of data contained within said information;
b) handing off said TCP/IP communication session from said first BTCP module to a selected back-end node over a persistent control channel; and
c) migrating a first TCP state of said first BTCP module to said selected back-end node, and sending a second TCP state of said selected back-end node to said first BTCP module over said control channel.

25. The computer system as described in claim 24, wherein said step a) of said method at said first BTCP module comprises the steps of:
a1) receiving a TCP/IP SYN packet from said client;
a2) selecting a first initial sequence number (ISN) for said first BTCP module that is associated with said TCP/IP communication session, said first ISN associated with a first TCP state of said first BTCP module;
a3) sending a TCP/IP SYN/ACK packet to said client;
a4) receiving a TCP/IP ACK packet from said client at said first BTCP module;
a5) receiving a HTTP request associated with said TCP/IP communication session; and
a6) storing said HTTP request and connection parameters associated with said TCP/IP SYN and TCP/IP ACK packets at said front-end node.

26. The computer system as described in claim 25, wherein said step b) of said method at said first BTCP module comprises the steps of:
b1) examining content of said HTTP request;
b2) determining which of said plurality of web server nodes, a selected back-end node, can best process said HTTP request based on said content;
b3) sending a handoff request message to a second BTCP module located at said selected back-end node over said control channel, if said selected back-end node is not said front-end node, said second BTCP module located below a second TCP module in a second operating system at said selected back-end node;
b4) including said connection parameters in said handoff request;
b5) including a first initial TCP state information for said first BTCP module, including said first ISN in said message; and
b6) receiving a handoff acknowledgment message from said second BTCP module if said TCP/IP communication session is successfully handed off.

27. The computer system as described in claim 26, wherein said step c) of said method at said second BTCP module comprises the further steps of:
c1) reconstructing said TCP/IP SYN packet using said connection parameters including changing a first destination IP address of said SYN packet to a second IP address of said selected back-end node;
c2) sending said TCP/IP SYN packet that is reconstructed to said second TCP module;
c3) receiving a second TCP/IP SYN/ACK packet from said second TCP module;
c4) parsing a second initial TCP state from said second TCP/IP SYN/ACK packet, including a second ISN for said second TCP module, said second initial TCP state necessary for understanding said second TCP state for said second TCP module in said TCP/IP communication session;
c5) reconstructing said TCP/IP ACK packet using said connection parameters including changing a second destination IP address of said TCP/IP ACK packet to said second IP address;
c6) updating said TCP/IP ACK packet to reflect said second TCP state of said selected back-end node in said TCP/IP communication session;
c7) sending said TCP/IP ACK packet that is reconstructed and updated to said second TCP module; and
c8) sending a handoff acknowledgment message to said first BTCP module.

28. The computer system as described in claim 27, wherein said step c) of said method further comprises the steps of:
c9) migrating said first initial TCP state to said second BTCP module over said control channel by including said first initial TCP state in said handoff request message, said first initial TCP state including said first ISN, such that said second BTCP module can calculate said first TCP state for said front-end node in said TCP/IP communication session; and
c10) sending said second initial TCP state of said selected back-end node to said first BTCP module by including said second initial TCP state in said handoff acknowledgment message, said second initial TCP state including said second ISN, such that said first BTCP module can calculate said second TCP state for said second TCP module in said TCP/IP communication session.

29. The computer system as described in claim 24, wherein said method at said first BTCP module comprises the further steps of:
d) receiving incoming data packets from said client;
e) changing destination addresses of said incoming data packets to a second IP address of said selected back-end node;
f) updating TCP sequence numbers and TCP checksum in said data packets to reflect said second TCP state of said selected back-end node; and
f) forwarding said data packets to said selected back-end server computer.

30. The computer system as described in claim 24, wherein said method comprises the further steps of:
d) intercepting outgoing response packets from said selected back-end node at a second bottom TCP module located below a second TCP module in a second operating system at said selected back-end node;
e) changing source addresses of said response packets to a first IP address of said first front-end node;
f) updating sequence numbers and TCP checksum in said response packets to reflect said first TCP state; and
g) sending said response packets to said client.

31. The computer system as described in claim 24, wherein said method comprises the further steps of:
d) monitoring TCP/IP control traffic for said TCP/IP communication session at a second BTCP module located below a second TCP module in a second operating system at said selected back-end node;
e) understanding when said TCP/IP communication session is closed at said second server computer;
f) sending a termination message to said first server computer over said control channel;
g) terminating said TCP/IP communication session at said front-end node; and
h) freeing data resources associated with said TCP/IP communication session at said front-end node.

32. The computer system as described in claim 24, wherein in said method each node in said web cluster can perform as said front-end node and as said selected back-end node.

33. The computer system as described in claim 24, if said selected back-end node is said front-end node, said method comprises the further steps of:
sending a reconstructed TCP/IP SYN packet from said first BTCP module to said first TCP module;
receiving a second TCP/IP SYN/ACK packet at said first BTCP module from said first TCP module;
parsing a third initial TCP state from said second TCP/IP SYN/ACK packet, said third initial TCP state associated with a third TCP state for said first TCP module in said TCP/IP communication session;
updating said TCP/IP ACK packet to reflect said third TCP state;
sending said updated TCP/IP ACK packet to said first TCP module;
updating incoming data packets from said client at said first BTCP module to reflect said third TCP state, including TCP sequences numbers and TCP checksum; and
updating outgoing response packets from said TCP module to reflect said first TCP state, including TCP sequence numbers and TCP checksum.
